(19) United States
(12) Patent Application Publication
(10) Pub. No.: US 2016/0299590 A1
(43) Pub. Date: Oct. 13, 2016

(54) CUSTOMIZATION METHOD, RESPONSE METHOD AND MOBILE TERMINAL FOR USER-DEFINED TOUCH

(71) Applicant: JRD COMMUNCATION INC.

(72) Inventor: YICHONG CHEN, Shenzhen (CN)

(21) Appl. No.: 14/899,881

(22) PCT Filed: Apr. 2, 2015
(86) PCT No.: PCT/CN2015/075771

§ 371 Date: Dec. 18, 2015

(30) Foreign Application Priority Data
Dec. 18, 2014 (CN) 201410799611.7

(51) Int. Cl. G06F 3/041

(52) U.S. Cl. CPC G06F 3/041

(57) ABSTRACT

The present invention discloses a customization method, a response method and a mobile terminal for user-defined touch, wherein the customization method includes: the mobile terminal turning on the touch customization mode; and in the touch customization mode, acquiring the distribution information of gripping positions at least on the sides of the mobile terminal when a user is holding the mobile terminal; saving the association relation between the distribution information of gripping positions and corresponding functions of the mobile terminal. With the customization method of the present invention, a user can, while holding a mobile terminal, customize touch actions corresponding to functions of the mobile terminal by using the distribution of gripping positions on the sides of the mobile terminal.

### TECHNICAL FIELD

The present invention relates to the field of mobile terminal technologies, and in particular relates to a customization method, a response method and a mobile terminal for user-defined touch.

### BACKGROUND

Electronic apparatuses are more and more extensively used in daily life. Along with the development of touchscreens, touchscreens are gradually taking the place of keyboards in electronic apparatuses, and touch-control input is increasingly used. For electronic apparatuses that currently have the capability of touch input, a corresponding touch operation may need to be performed to implement a function. To apply functions of electronic apparatuses in an expansive range, manufacturers of touchscreens or electronic apparatuses may set touch operations corresponding to the functions. To some functions, however, a user may desire to be able to set related touch actions on his own.

When a touch action is customized according the prior art, it may have required that the touch action be set up on the front of an electronic apparatus. When the touch action is specifically performed to implement the related function, two hands may be needed for the operation so as to carry out the touch action on the front of the electronic apparatus, leading to an inconvenient operation for users.

### SUMMARY

The present invention includes a customization method, a response method and a mobile terminal for user-defined touch, which can customize touch actions corresponding to functions of a mobile terminal by using gripping positions on the sides of the mobile terminal when a user is holding the mobile terminal.

The present invention provides a customization method for user-defined touch, comprising: the mobile terminal turning on the touch customization mode; detecting if the mobile terminal has a touch response, and if there is no response, repeating the step of detecting if the mobile terminal has a touch response, and going to the subsequent steps if there is a response; and in the touch customization mode, acquiring the distribution information of gripping positions at least on the sides of the mobile terminal when a user is holding the mobile terminal, and determining functions of the mobile terminal corresponding to the distribution information of gripping positions; saving the association relation between the distribution information of gripping positions and corresponding functions of the mobile terminal.

In an embodiment, a method of acquiring the distribution information of gripping positions at least on sides of the mobile terminal when a user is holding the mobile terminal, and determining functions of the mobile terminal corresponding to the distribution information of gripping positions comprises: acquiring the distribution information of gripping positions on the sides of the mobile terminal when the user is holding the mobile terminal, and acquiring the information of touch actions on the sides or front of the mobile terminal, and determining functions of the mobile terminal corresponding to the distribution information of gripping positions and acquiring the information of touch actions on the sides or front of the mobile terminal; saving the association relation between the distribution information of gripping positions and corresponding functions of the mobile terminal comprises: saving the association relation between the distribution information of gripping positions and the information of touch actions and the corresponding functions of the mobile terminal.

In an embodiment, acquiring the distribution information of gripping positions at least on the sides of the mobile terminal when a user is holding the mobile terminal comprises: when the user holds the mobile terminal, the touchscreen of the mobile terminal senses a touch response generated by a hand of the user approaching or touching the side of the touchscreen; and based on the settings of the side axes in the mobile terminal, recording the side axis coordinate information corresponding to the gripping sensed by the touchscreen, and recording the coordinate information representing the distribution information of gripping positions.

The present invention further provides a response method for user-defined touch, comprising: a mobile terminal acquiring the distribution information of gripping positions at least on the sides of the mobile terminal when a user is holding the mobile terminal; determining if an association relation exists between the distribution information of gripping positions and at least one function of the mobile terminal; and only if it exists, carrying out the at least one function of the mobile terminal.

In an embodiment, acquiring the distribution information of gripping positions at least on the sides of the mobile terminal when a user is holding the mobile terminal comprises: acquiring the distribution information of gripping positions on the sides of the mobile terminal when the user is holding the mobile terminal, and the information of touch actions on the sides or front of the mobile terminal. The step of determining if an association relation exists between the distribution information of gripping positions and at least one function of the mobile terminal comprises: determining if an association relation exists between the distribution information of gripping positions and the information of touch actions and between at least one function of the mobile terminal.

In an embodiment, acquiring the distribution information of gripping positions at least on the sides of the mobile terminal when a user is holding the mobile terminal comprises: when the user holds the mobile terminal, the touchscreen of the mobile terminal senses a touch response generated by a hand of the user approaching or touching the side of the touchscreen; based on the settings of the side axes in the mobile terminal, recording the side axis coordinate information corresponding to the gripping sensed by the touchscreen, the coordinate information representing the distribution information of gripping positions.

The present invention further provides a mobile terminal for user-defined touch, comprising: a customization unit configured to turn on the touch customization mode; a sensing unit connected to the customization unit and configured to, in the touch customization mode, acquire the distribution information of gripping positions at least on the sides of the mobile terminal when a user is holding the mobile terminal, and determine functions of the mobile terminal corresponding to the distribution information of gripping positions; a memory unit connected to the customization unit and the sensing unit, and configured to save the association relation between the distribution information of gripping positions and corresponding functions of the mobile terminal.

In an embodiment, the sensing unit is further configured to, in the touch customization mode, acquire the distribution information of gripping positions on the sides of the mobile terminal when the user is holding the mobile terminal, and the information of touch actions on the sides or front of the mobile terminal, and determine functions of the mobile terminal corresponding to the distribution information of gripping positions and the information of touch actions on the sides or front of the mobile terminal; the memory unit is further configured to save the association relation between the distribution information of gripping positions and the information of touch actions and the corresponding functions of the mobile terminal.

In an embodiment, the mobile terminal further comprises a coordinate axis unit, which may be connected to the sensing unit and the memory unit; the sensing unit may be a touchscreen, and when the user holds the mobile terminal, the touchscreen senses a touch response generated by a hand of the user approaching or touching the side of the touchscreen; the coordinate axis unit may be configured to record the side axis coordinate information corresponding to the gripping sensed by the touchscreen, and transmit the coordinate information as the distribution information of gripping positions to the memory unit.

In an embodiment, the touchscreen comprises a body part disposed on the front of the mobile terminal and a bending part extending from the body part and bent to the sides of the mobile terminal.

Advantageous effects of the examples of the present application include: unlike the prior art, the mobile terminal according the present invention first turns on the touch customization mode, and in this mode, acquires the distribution information of gripping positions on a side of the mobile terminal generated when a user is gripping the mobile terminal. When using a mobile terminal, a user may need to grip the mobile terminal, which then may generate gripping positions on the side of the mobile terminal. The distribution information of gripping positions is recorded, and the distribution information of gripping positions is associated with functions of the mobile terminal. The association relation is saved so as to complete the customization of touch actions corresponding to the functions of the mobile terminal. When the touch customization is completed, a user can implement the functions of the mobile terminal through simple gripping actions, which may better fit users' operation habits. When a user is holding the mobile terminal, the present invention can customize touch actions corresponding to functions of the mobile terminal by using the distribution of gripping positions on the sides of the mobile terminal.

### BRIEF DESCRIPTION OF THE DRAWINGS

FIG. 1 depicts a flow chart of a first embodiment of a customization method for user-defined touch according to the present invention;

FIG. 2 depicts a flow chart of a second embodiment of the customization method for user-defined touch according to the present invention;

FIG. 3 illustrates a selection interface of functions of a mobile terminal in need of customized touch actions;

FIG. 4 illustrates a distribution of gripping positions when a user is holding the mobile terminal;

FIG. 5 illustrates gripping positions when a user is holding the mobile terminal and the user's fingers are sliding;

FIG. 6 is a flow chart of an embodiment of the response method for user-defined touch according to an embodiment of the present invention;

FIG. 7 is a flow chart of a further embodiment of the response method for user-defined touch according to the present invention;

FIG. 8 illustrates the structure of an embodiment of the mobile terminal for user-defined touch according to the present invention.

### DETAILED DESCRIPTION

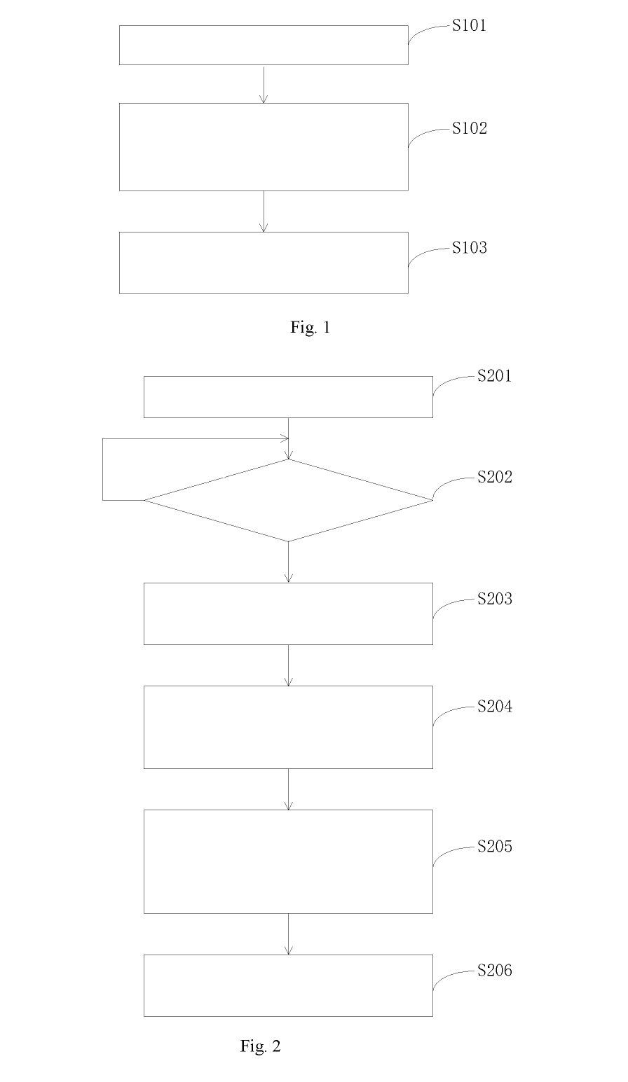

FIG. 1 is a flow chart of an embodiment of a customization method for user-defined touch according to the present invention, and the present embodiment provides a customization method, comprising the following steps:

Step S101 may include: the mobile terminal turning on the touch customization mode.

In an embodiment, all mobile terminals with the capability of touch input can realize touch customization, wherein the mobile terminals with the capability of touch input may be cell phones, tablets, etc., and the touch input may be achieved through capacitive or inductive touchscreens, or may be achieved through thermosensitive, pressure or biological signal sensors disposed inside the mobile terminals.

A mobile terminal may turn on the touch customization mode through an operating system, and by setting up virtual keys that are turned on in the system functions. When the touch customization mode is turned on, functions of the mobile terminal may be customized, e.g. unlocking, locking the screen, adjusting the volume, sliding the screen, etc.; alternatively, the touch customization mode may be turned on through an APP. If a user desires to customize touch operations corresponding to functions of the mobile terminal, then the APP can be installed, and the APP can be opened to implement touch customization. If the user does not need customization of relevant touch actions, there is no need to install the APP in the mobile terminal.

Step S102 may include: in the touch customization mode, acquiring the distribution information of gripping positions at least on the sides of the mobile terminal when a user is holding the mobile terminal, and determining functions of the mobile terminal corresponding to the distribution information of gripping positions.

When the touch customization mode is turned on, the user can hold the mobile terminal, and there are corresponding gripping positions on the sides of the mobile terminal. If the mobile terminal has a relatively small size, the distribution of gripping positions may appear on both sides even with single-handed operations; if the mobile terminal has a relatively large size, the distribution of gripping positions may only appear on one single side with single-handed operations, while operations with both hands may lead to the distribution of gripping positions on both sides. In the present embodiment, the distribution information of gripping positions on either a single side or on two sides can be used to implement customization in light of the above situations.

The mobile terminal can acquire the distribution information of gripping positions through a touchscreen or sensor. For example, a touchscreen that is bendable to the sides can sense the touch by a user hand during gripping, and then the distribution information of gripping positions can be learned through the position of the touchscreen where the sensing takes place. Alternatively, a plurality of temperature sensors may be disposed on the sides of the mobile terminal. When the user is gripping, the temperature sensors corresponding to the hands can sense the temperature, and the positions of these temperature sensors that sense the temperature are the gripping positions. It can be thought that the temperature sensors may be replaced by pressure sensors or biological signal sensors.

Certainly, during the implementation of touch customization, touch actions performed by the user not only may comprise the distribution of gripping positions, but also may comprise other touch actions during gripping. For example, if the thumb slides up and down along a side during gripping, clicking actions by one single finger or multiple fingers during gripping may occur, and sliding or clicking on the front of the mobile terminal during gripping may occur. Similarly, the mobile terminal may also acquire associated information of the above touch actions through a touchscreen or sensors.

It is necessary to determine functions of the mobile terminal corresponding to the touch customization by the user, namely to associate the touch actions performed by the user with the functions of the mobile terminal.

Step S103 may include: saving the association relation between the distribution information of gripping positions and corresponding functions of the mobile terminal.

When the user is holding the mobile terminal and performs a touch action, both the user and the mobile terminal can specify the function of the mobile terminal corresponding to the holding action. When the mobile terminal acquires the distribution information of gripping positions, the distribution information of gripping positions may be associated with the corresponding functions of the mobile terminal, and the association relation can be saved. If the information of the touch actions of the user further comprises information like other clicking or sliding in addition to the distribution information of gripping positions, all of the touch action information can be associated with the corresponding functions of the mobile terminal, and the association relation can be saved.

Unlike the prior art, the mobile terminal in the present embodiment may first turn on the touch customization mode, and in this mode, the mobile terminal may acquire the distribution information of gripping positions at least on the sides of the mobile terminal, that is generated when a user is gripping the mobile terminal. When using a mobile terminal, a user may need to grip the mobile terminal, thereby generating gripping positions on the sides of the mobile terminal. The distribution information of gripping positions is recorded, the distribution information of gripping positions is associated with functions of the mobile terminal, and the association relation is saved so as to complete the customization of touch actions corresponding to the functions of the mobile terminal. When the touch customization is completed, a user can implement the functions of the mobile terminal just through simple gripping actions, which makes the user operations more convenient and simple, and better fits users' operation habits. When a user is holding the mobile terminal, the present invention can customize touch actions corresponding to functions of a mobile terminal by using the distribution of gripping positions on the sides of the mobile terminal.

FIG. 2 depicts a flow chart of a further embodiment of the customization method for user-defined touch according to the present invention. The present embodiment provides a customization method, comprising the following steps:

Step S201 may include: the mobile terminal turning on the touch customization mode.

Step S201 in the present embodiment may be similar to Step S101 in the first embodiment of the customization method, which will not be described herein. It should be noted that the mobile terminal in the present embodiment has a related APP for implementing touch customization, and the opening of the APP turns on the touch customization mode. In the present embodiment, the mobile terminal is a cell phone, which can achieve the input of a touch action through the touchscreen that is bendable to the sides.

Step S202 may include: detecting if the mobile terminal has a touch response, and if there is a response, going to Step S203, and if there is no response, repeating the step S202.

After entering the touch customization mode, touch response detection can be carried out, which may need to detect if a corresponding response amount is generated by the sides and front of the touchscreen. To implement the detection, a plurality of detection points may be disposed on the touchscreen, for example, two end points and the central point of a touchscreen side, four corners and the central point of the touchscreen front, and the calibration of the touchscreen may be implemented at the same time with the detection. During the detection, if each detection point has a response amount, it is concluded that the detection is completed, and the detection proceeds to Step S203, namely the touch customization can be achieved through this APP. If there is no response, then the detection action is repeated. Whether the touch detection is completed may also be determined by determining if a response takes place at the sides during gripping.

Step S203 may include: prompting the user to hold the mobile terminal and carry out a touch action against a function of the mobile terminal.

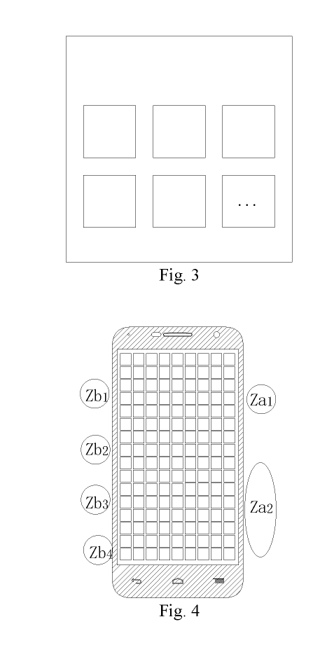

When the detection in Step S202 is completed, the mobile terminal prompts the user to select a function for touch customization. Specifically, when the test is completed, the APP enters the function selection interface, and can select functions such as volume adjustment, screen locking, image zoom in and out, and screen sliding. FIG. 3 illustrates the selection interface of functions of a mobile terminal in need of customized touch actions. When a function of the mobile terminal is selected, the user enters the customization interface, and can begin the customization of touch actions. During the customization, the user needs to hold the mobile terminal, thereby generating touch responses on the sides of the mobile terminal.

Step S203 may also be carried out prior to Step S201. Step S203 may include first, determining a function of a mobile terminal in need of customized touch actions, and then turning on the corresponding touch customization mode for this function.

Step S204 may include: when the user holds the mobile terminal, the mobile terminal may sense a touch response generated by a hand of the user approaching or touching the side of the mobile terminal

During this process, the mobile terminal can sense a touch response at least on the side, and at the same time, the user may also perform other touch actions. For example, the touch action that locks the screen is gripping both sides of a cell phone; the touch action to adjust the volume is gripping both sides of a cell phone and sliding the index finger on the side; the touch action to zoom in or out an image is gripping both sides of a cell phone and tapping twice the side screen with a thumb; the touch action to slide the screen is gripping both sides of a cell phone and sliding the thumb on the side of the cell phone.

To facilitate a user in setting up a touch action, when a touch action is performed, the touch action that the user is performing can be simulated and displayed correspondingly on the customization interface of the APP. When the touch action is completed, it allows the user to determine if the touch action acquired by the mobile terminal is correct.

Step S205 may include: based on the settings of the side axes in the mobile terminal, recording the side axis coordinate information corresponding to the gripping sensed by the mobile terminal, wherein the coordinate information represents the distribution information of gripping positions.

Specifically, all of the above touch actions can be recorded through the settings of coordinate axes, the front touchscreen of the mobile terminal has a two-dimensional coordinate axis (X, Y), and the side touchscreen has two one-dimensional coordinate axes Za and Zb. Different gripping actions have different coordinate information. FIG. 4 illustrates the distribution of gripping positions when a user is holding the mobile terminal. In FIG. 4, the touch action includes gripping both sides of a cell phone. This results in two touch points on the coordinate axis Z1, and four touch points on the coordinate axis Z2, and the coordinate information is recorded as ((Za₁, Za₂), (Zb₁, Zb₂, Zb₃, Zb₄));

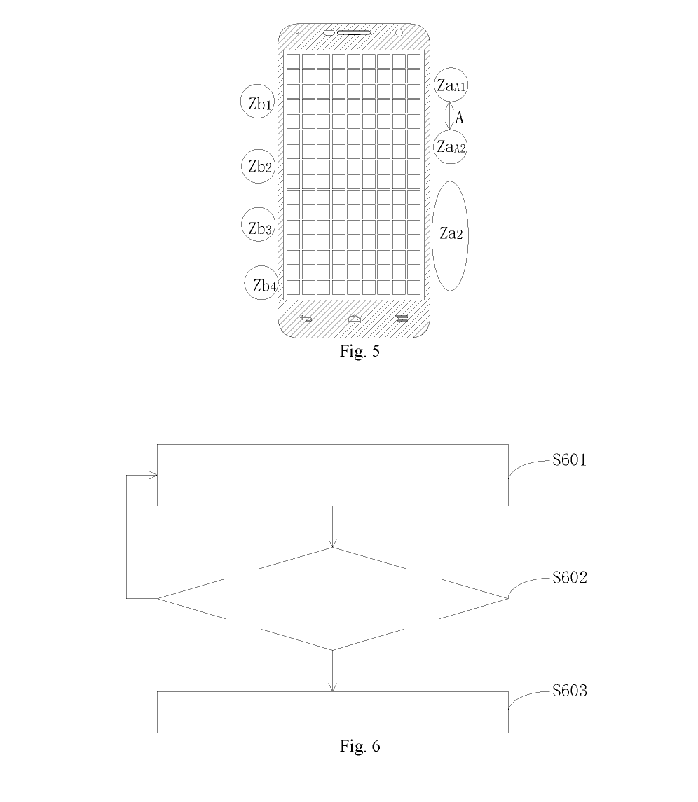

In the present embodiment, vector information can also be recorded through the coordinate information, namely a sliding touch action can be recorded through the vector information. FIG. 5 illustrates the gripping positions when a user is holding the mobile terminal and the user's fingers are sliding. FIG. 5 contains the information of gripping positions and the sliding information. For the thumb sliding, for example, the recorded coordinate information is ((A, Za₂), (Zb₁, Zb₂, Zb₃, Zb₄)), wherein A is a vector, and the coordinate position is from Za_{A1} to Za_{A2}, which is recorded as (Za_{A1}, Za_{A2}). For a touch action with multiple clicking, multiple pulse signals are generated at the same position of the touchscreen to realize the sensing, and the action of multiple clicking is recorded with a counter disposed in the mobile terminal. Specifically, the corresponding touch action information comprises the information of gripping positions and the corresponding information of clicking times. With the gripping mode in FIG. 4 as an example, the touch action information is ((Za₁, Za₂), ((Zb₁, t), Zb₂, Zb₃, Zb₄)), which indicates the number of clicking times t at the same coordinate position Zb₁. The corresponding touch action by the user includes gripping the cell phone and making t clicks by the index finger, wherein the number of times the finger clicks t≧2.

When holding the mobile terminal, the user can certainly further perform touch actions on the front of the touchscreen, including the sliding, clicking and touching by a finger on the front. For the front touch actions, related information is recorded through the X axis and the Y axis.

Step S206 may include: saving the association relation between the distribution information of gripping positions and corresponding functions of the mobile terminal.

When the settings of touch actions corresponding to functions of the mobile terminal are completed, the association between the touch action information and the function of the mobile terminal is completed via the APP, wherein the touch action information comprises the information of gripping positions. Finally, the association relation is saved in the mobile terminal.

Unlike the prior art, after the mobile terminal in the present embodiment turns on the touch customization mode, in this mode, a user selects an associated function of the mobile terminal for touch customization. During the process of touch customization, the user needs to grip the mobile terminal, and generate corresponding gripping positions on the sides of the mobile terminal, based on which the user may continue to perform touch actions. The distribution of gripping positions and the function of the mobile terminal are associated and the association relation is saved. When the touch customization is completed, the user performs simple touch actions on the basis of holding the mobile terminal, which can implement corresponding functions of the mobile terminal and make the user operations more convenient and simple.

FIG. 6 is a flow chart of a first embodiment of the response method for user-defined touch according to the present invention, and the response method provided by the present embodiment comprises the following steps:

Step S601 may include: a mobile terminal acquiring the distribution information of gripping positions at least on the sides of the mobile terminal when a user is holding the mobile terminal.

To implement functions of a mobile terminal, a user can hold the mobile terminal and performs touch actions, and at this time, the mobile terminal acquires the distribution information of gripping positions at least on the sides of the mobile terminal. The acquiring process is similar to the step S102 in the first embodiment of the customization method for user-defined touch, which will not be described herein.

Step S602 may include: determining if an association relation exists between the distribution information of gripping positions and at least one function of the mobile terminal; if it exists, going to Step S603, and if it does not exist, returning to Step S601.

When the touch customization is completed, the association relation between the functions of the mobile terminal and touch actions can be saved in the mobile terminal. In the step S602, based on the association relation saved in the mobile terminal, determining if the distribution information of gripping positions obtained in the above step S601 is associated with at least one function of the mobile terminal. If the association exists, it is concluded that the touch action produced when the user holds the mobile terminal is valid, and it can trigger the mobile terminal to implement the related function. If the association does not exist, the function desired by the user cannot take place, resulting in returning to Step S601. The user holds the mobile terminal again to perform a touch action, while the mobile terminal re-acquires the distribution information of gripping positions at least on the sides of the mobile terminal.

Step S603 may include: carrying out the at least one function of the mobile terminal.

As the above description of the step S602 illustrates, when the association relation is determined, the at least one function of the mobile terminal is started.

Unlike the prior art, the mobile terminal in the present embodiment has completed the touch customization and saved the association relation between touch actions and functions. When a user performs a touch action so as to implement a function of the mobile terminal, the mobile terminal first acquires the distribution information of gripping positions at least on the sides of the mobile terminal when the user is holding the mobile terminal, and then based on the saved association relation, determines if an association relation exists between the distribution information of gripping positions and a function of the mobile terminal If an association relation exists, the mobile terminal carries out the function. Through this embodiment, the user just needs to perform simple gripping actions, or perform simple touch actions on the basis of gripping, to implement related functions of the mobile terminal, making user operations convenient and simple.

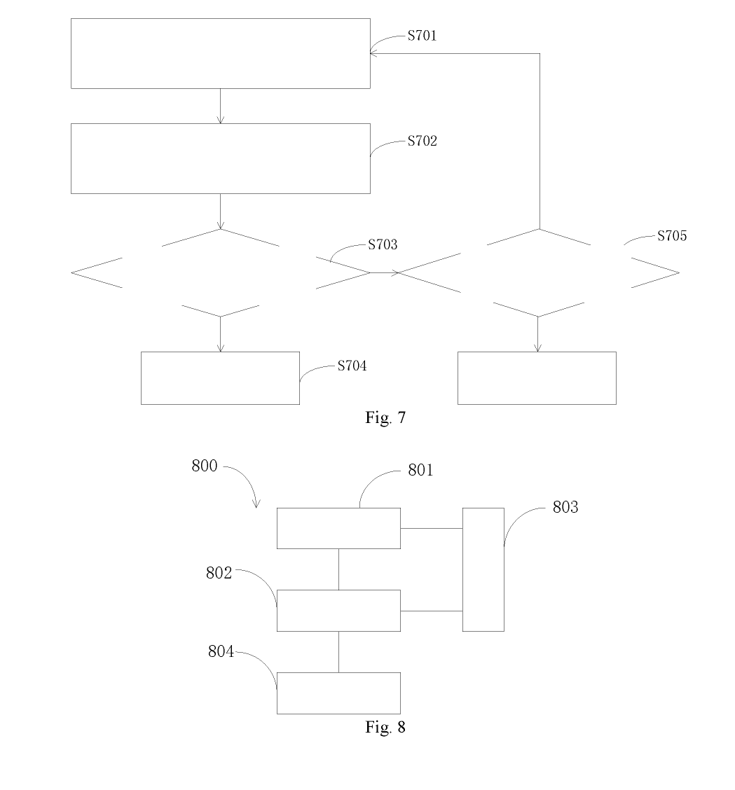

FIG. 7 is a flow chart of a second embodiment of the response method for user-defined touch according to the present invention, and the response method provided by the present embodiment comprises the following steps:

Step S701 may include: when the user holds the mobile terminal, the touchscreen of the mobile terminal senses a touch response generated by a hand of the user approaching or touching the side of the touchscreen.

In an embodiment, the mobile terminal is a cell phone and senses touch actions by a user through the touchscreen. The sensing process in the step S701 is similar to the step S204 in the second embodiment of the customization method for user-defined touch, which will not be described herein.

Step S702 may include: based on the settings of the side axes in the mobile terminal, recording the side axis coordinate information corresponding to the gripping sensed by the touchscreen, with the coordinate information representing the distribution information of gripping positions.

The sensing process in the step S702 is similar to the step S205 in the second embodiment of the customization method for user-defined touch, which will not be described herein.

Step S703 may include: determining if an association relation exists between the distribution information of gripping positions and at least one function of the mobile terminal; if it exists, going to Step S704, if it does not exist, going to Step S705.

When acquiring the distribution information of gripping positions according to touch actions by a user, the mobile terminal may simultaneously acquire the information of touch actions. It can determine if an association relation exists between the acquired information and a function of the mobile terminal. If the association exists, it is concluded that the touch action produced when the user holds the mobile terminal is valid, and it can trigger the mobile terminal to implement the related function. If the association does not exist, the function desired by the user cannot take place, the number of times that the user performs the touch actions is recorded, and Step S705 is executed.

Step S704 can include: carrying out the at least one function of the mobile terminal.

As the above description of the step S703 illustrates, when the association relation is determined, the at least one function of the mobile terminal is started.

Step S705 may include: recording the number of times that the user performs the touch action, determining if the number of times exceeds a threshold, and if the threshold is exceeded, stopping the touch response; if the threshold is not exceeded, returning to the step S701.

When the number of times of touch actions is recorded, step S705 includes determining if the number of times of touch actions exceeds a threshold, and if the threshold is exceeded, stopping the touch response; if it is not exceeded, re-acquiring the information of touch actions. The purpose of this step is that, if a touch action has been repeated many times and it is determined that no association exists in all cases, it is necessary to end the acquisition of the distribution information of gripping positions by the mobile terminal so as not to further waste time or power. Therefore, a threshold is set for the number of times touch actions occur in the step S705. When the number of times of touch actions exceeds the threshold, step S705 includes stopping the action by the mobile terminal to acquire the distribution information of gripping positions, and if the number of times does not exceed the threshold, continuing the touch action.

Unlike the prior art, the mobile terminal in the present embodiment completes the touch customization and saves the association relation between touch actions and functions. When a user performs a touch action so as to implement a function of the mobile terminal, the mobile terminal first acquires the distribution information of gripping positions at least on the sides of the mobile terminal when the user is holding the mobile terminal, and then according to the saved association relation, determines if an association relation exists between the distribution information of gripping positions and a function of the mobile terminal. If an association relation exists, the function is carried out. Through this embodiment, the user just needs to perform simple gripping actions, or perform simple touch actions on the basis of gripping, to implement related functions of the mobile terminal, such that user operations are more convenient and simple.

FIG. 8 illustrates the structure of a first embodiment of the mobile terminal for user-defined touch according to the present invention. The present embodiment provides a mobile terminal 800, which comprises a customization unit 801, a sensing unit 802, a memory unit 803 and a coordinate axis unit 804. The customization unit 801 is connected to the sensing unit 802, the memory unit 803 is connected to the customization unit 801 and the sensing unit 802, and the coordinate axis unit 804 is connected to the sensing unit 802.

A specific operating process of the mobile terminal 800 is as follows:

Step S801 may include: the customization unit 801 turning on the touch customization mode;

Step S802 may include: the customization unit 801 triggering the sensing unit 802 to prompt the user to take the touch test, the sensing unit 702 receiving the touch signal and transmiting the touch signal to the customization unit for determination of the test result;

Step S803 may include: when the customization unit 801 determines that the touch test is passed, it prompts the user to select a function for touch customization;

Step S804 may include: the sensing unit 802 sensing and acquiring the distribution information of gripping positions at least on the sides of the mobile terminal 800 when the user is holding the mobile terminal 800;

Specifically, the sensing unit 802 is a touchscreen, the touchscreen comprises a body part disposed on the front of the mobile terminal and a bending part extending from the body part and bent to the sides. The touchscreen is connected to the coordinate axis unit 804, and can record specific gripping positions and touch actions through the coordinate axis unit 804.

Step S805 may include: the customization unit 801 associating the distribution information of gripping positions with the function selected by the user;

If the sensing unit 802 senses the distribution information of gripping positions and the information of touch actions, then in the step S805, the customization unit 801 associates both the distribution information of gripping positions and the information of touch actions with corresponding functions.

Step S806 may include: the memory unit 803 saving the association relation.

Functions of the above units correspond to the steps in the second embodiment of the customization method for user-defined touch, which will not be specifically described herein.

Unlike the prior art, the present embodiment achieves customization of touch actions through the customization mode, acquires, by a sensing module, the distribution information of gripping positions generated on the sides when a user is holding a mobile terminal, and saves, by a memory module, the association between the gripping information and touch actions. When the touch customization is completed, the user performs simple touch actions on the basis of holding the mobile terminal, which can implement corresponding functions of the mobile terminal and make the user operations more convenient and simple.

Only embodiments of the present invention are described above, which are not intended to limit the scope of the present invention. Any equivalent structure or equivalent procedure variation made according to the Specification and Drawings of the present invention, or direct or indirect applications in other related technical fields, shall similarly be encompassed by the present invention.

1. A customization method for user-defined touch, wherein the customization method comprises:
a mobile terminal turning on the a touch customization mode;
detecting if the mobile terminal has a touch response until the mobile terminal has a touch response;
in response to detection of the mobile terminal touch response:
in a touch customization mode, acquiring distribution information of gripping positions at least on sides of the mobile terminal when a user is holding the mobile terminal, and determining functions of the mobile terminal corresponding to the distribution information of gripping positions; and
saving an association relation between the distribution information of gripping positions and corresponding functions of the mobile terminal.

2. The customization method according to claim 1, wherein acquiring the distribution information of gripping positions at least on the sides of the mobile terminal when a user is holding the mobile terminal, and determining functions of the mobile terminal corresponding to the distribution information of gripping positions comprises:
acquiring the distribution information of gripping positions on the sides of the mobile terminal when the user is holding the mobile terminal, and information of touch actions on the sides or a front of the mobile terminal, and determining functions of the mobile terminal corresponding to the distribution information of gripping positions and the information of touch actions on the sides or front of the mobile terminal;
saving the association relation between the distribution information of gripping positions and corresponding functions of the mobile terminal comprises:
saving the association relation between the distribution information of gripping positions and the information of touch actions and the corresponding functions of the mobile terminal.

3. The customization method according to claim 1, wherein acquiring the distribution information of gripping positions at least on the sides of the mobile terminal when a user is holding the mobile terminal comprises:
a touchscreen of the mobile terminal sensing a touch response generated when a hand of the user approaches or touches one of the sides of the mobile terminal when the user holds the mobile terminal; and
based on the settings of side axes in the mobile terminal, recording the side axis coordinate information corresponding to the touch response sensed by the touchscreen, and coordinate information representing the distribution information of gripping positions.

4. A response method for user-defined touch, wherein the method comprises:
a mobile terminal acquiring distribution information of gripping positions at least on the sides of the mobile terminal when a user is holding the mobile terminal;
determining if an association relation exists between the distribution information of gripping positions and at least one function of the mobile terminal; and
in response to the association relation existing, carrying out the at least one function of the mobile terminal.

5. The response method according to claim 4, wherein acquiring the distribution information of gripping positions at least on the sides of the mobile terminal when a user is holding the mobile terminal comprises:
acquiring the distribution information of gripping positions on the sides of the mobile terminal when the user is holding the mobile terminal, and acquiring information of touch actions on sides or a front of the mobile terminal;
determining if an association relation exists between the distribution information of gripping positions and at least one function of the mobile terminal comprises:
determining if an association relation exists between the distribution information of gripping positions and the information of touch actions and the at least one function of the mobile terminal.

6. The response method according to claim 4, wherein acquiring the distribution information of gripping positions at least on the sides of the mobile terminal when a user is holding the mobile terminal comprises:
a touchscreen of the mobile terminal sensing a touch response generated when a hand of the user approaches or touches one of the sides of the mobile terminal when the user holds the mobile terminal;
based on the settings of side axes in the mobile terminal, recording side axis coordinate information corresponding to the touch response sensed by the touchscreen, the coordinate information representing a distribution information of gripping positions.

7. A mobile terminal for user-defined touch, wherein the mobile terminal comprises:
a customization unit configured to turn on a touch customization mode;
a sensing unit connected to the customization unit and configured to, in the touch customization mode, acquire distribution information of gripping positions at least on the sides of the mobile terminal when a user is holding the mobile terminal, and determine functions of the mobile terminal corresponding to the distribution information of gripping positions; and
a memory unit connected to the customization unit and the sensing unit, and configured to save an association relation between the distribution information of gripping positions and corresponding functions of the mobile terminal.

8. The mobile terminal according to claim 7, wherein the sensing unit is further configured to, in the touch customization mode, acquire the distribution information of gripping positions on the sides of the mobile terminal when the user is holding the mobile terminal, and acquire information of touch actions on the sides or front of the mobile terminal, and determine functions of the mobile terminal corresponding to the distribution information of gripping positions and the information of touch actions on the sides or front of the mobile terminal; and
the memory unit is further configured to save the association relation between the distribution information of gripping positions and the information of touch actions and the corresponding functions of the mobile terminal.

9. The mobile terminal according to claim 7, wherein the mobile terminal further comprises a coordinate axis unit, which is connected to the sensing unit and the memory unit;
wherein the sensing unit is a touchscreen, and when the user holds the mobile terminal, the touchscreen senses a touch response generated by a hand of the user approaching or touching the side of the touchscreen;
the coordinate axis unit is configured to record the side axis coordinate information corresponding to the gripping sensed by the touchscreen, and transmit the coordinate information as the distribution information of gripping positions to the memory unit.

10. The mobile terminal according to claim 9, wherein the touchscreen comprises a body part disposed on the front of the mobile terminal and a bending part extending from the body part and bent to the sides of the mobile terminal.

11. The customization method of claim 1, wherein the touch response is recoded with a temperature sensor.

12. The customization method of claim 1, wherein the touch response is recorded with a pressure sensor.

13. The customization method of claim 1, wherein the touch response is recorded with a biological signal sensor.

14. The response method according to claim 4, wherein the mobile terminal acquires the distribution information of the gripping positions simultaneously while the mobile terminal acquires the information of touch actions.

15. The response method according to claim 6, wherein the mobile terminal stops the touch response if a count of the number of times the touch response is performed exceeds a threshold.

16. The response method according to claim 4, wherein a sensing unit prompts the user to take a touch test.

17. The mobile terminal according to claim 8, wherein the information of touch actions includes sliding.

18. The mobile terminal according to claim 8, wherein the information of touch actions includes clicking.

19. The mobile terminal according to claim 18, wherein the clicking is counted with a counter on the mobile terminal.

20. The mobile terminal according to claim 17, wherein the information of touch actions sliding includes vector information.
